(19) United States
(12) Patent Application Publication
(10) Pub. No.: US 2026/0057358 A1
(43) Pub. Date: Feb. 26, 2026

(54) RESOURCE DISTRIBUTION VIA USER SELECTABLE DISTRIBUTION MODES

(71) Applicant: THE HUNTINGTON NATIONAL BANK, Columbus, OH (US)

(72) Inventors: Jignesh J. Jethva, Columbus, OH (US); Suhas D. Gosavi, Columbus, OH (US); Elizabeth McNally, Columbus, OH (US)

(73) Assignee: THE HUNTINGTON NATIONAL BANK, Columbus, OH (US)

(21) Appl. No.: 18/812,360

(22) Filed: Aug. 22, 2024

(51) Int. Cl. G06Q 20/10

(52) U.S. Cl. CPC G06Q 20/102

(57) ABSTRACT

A system for facilitating selection of one or more preferred resource modes of distribution is disclosed. A plurality of selectable interface objects may be presented on a user interface of a user computing device. Each of the plurality of interface objects may represent a different selectable mode of distribution by which a resource can be distributed. The modes of distribution to be presented by the representative interface objects may be determined in various ways, including on the basis of predicted user-preferred modes of distribution output by a trained machine-learning model. The system may also receive an indication of desired allocation of the resource to each selected mode of distribution. The resource may be subsequently distributed according to the selected modes of distribution and the indicated resource allocation.

### TECHNICAL FIELD

The present disclosure relates generally to user interaction with computing infrastructure, and more particularly, although not exclusively, to facilitating user selection of preferred resource modes of distribution via customizable user interfaces.

### BACKGROUND

Resources may be distributed between parties for various reasons, such as for example, to procure items, or as an exchange of one resource for another. It is common, particularly when the transferor of a resource is a business and the receiver of a resource is an individual, for the transferor to determine the mode of distribution of the resource to the receiver with little to no receiver input. This may be the case at least because allowing a receiver to have control over the selection of a mode(s) of distribution by which a resource will be received may reduce process efficiency. Nonetheless, distributing resources without receiver input as to the mode of distribution may result in receiver dissatisfaction, lack of resource acceptance, or other problems that may also unnecessarily consume computing and human resources, and may further cause unwanted tracking, reporting, or other issues for transferors of resources.

### SUMMARY

According to one example, a system may include a processor and a memory that is communicatively coupled to the processor, the memory comprising instructions that are executable by the processor to cause the processor to perform operations. The operations may include displaying on a computing device of a user, a user interface of a remote computing system, the user interface including a plurality of interface objects each of which represents a different mode of distribution by which a resource is distributable to the user, the modes of distribution selected for presentation based on one or more of a resource type and a resource value. The operations may also include detecting, via the user interface, a selection of at least two interface objects of the plurality of interface objects, and receiving, via the user interface, an indicated allocation of the resource to each mode of distribution represented by the selection of the at least two interface objects. The operations may additionally include, in response to detecting the selection of the at least two interface objects and receiving the indicated allocation of the resource, initiating a distribution of the resource according to the selected modes of distribution and the indicated resource allocation.

According to a another example, a computer-implemented method may include displaying on a computing device of a user, a user interface of a remote computing system, the user interface including a plurality of interface objects each of which represents a different mode of distribution by which a resource is distributable to the user, the modes of distribution selected for presentation based on one or more of a resource type and a resource value. The method may also include detecting, via the user interface, a selection of at least two interface objects of the plurality of interface objects, and receiving, via the user interface, an indicated allocation of the resource to each mode of distribution represented by the selection of the at least two interface objects. The method may additionally include, in response to detecting the selection of the at least two interface objects and receiving the indicated allocation of the resource, initiating a distribution of the resource according to the selected modes of distribution and the indicated resource allocation.

According to a further example, a non-transitory computer readable medium may contain instructions that are executable by a processor for causing the processor to perform operations. The operations may include displaying on a computing device of a user, a user interface of a remote computing system, the user interface including a plurality of interface objects each of which represents a different mode of distribution by which a resource is distributable to the user, the modes of distribution selected for presentation based on one or more of a resource type and a resource value. The operations may also include detecting, via the user interface, a selection of at least two interface objects of the plurality of interface objects, and receiving, via the user interface, an indicated allocation of the resource to each mode of distribution represented by the selection of the at least two interface objects. The operations may additionally include, in response to detecting the selection of the at least two interface objects and receiving the indicated allocation of the resource, initiating a distribution of the resource according to the selected modes of distribution and the indicated resource allocation.

### BRIEF DESCRIPTION OF THE DRAWINGS

FIG. 1 is a block diagram of a customizable first user interface via which a user can select one or more preferred modes of distribution of a resource according to one example.

FIG. 2 is a block diagram of a customizable second user interface via which a user can indicate an allocation of the resource across multiple modes of distribution selected from the first user interface according to one example.

FIG. 3 is a block diagram of a machine-learning-based system for generating and presenting a user with various selectable modes of distribution for a resource according to one example.

FIG. 4 is a block diagram of an application for training a machine-learning model according to one example.

FIG. 5 is a block diagram illustrating various computing components of the machine-learning-based system of FIG. 3 according to one example.

FIG. 6 is a flowchart of a computer-implemented method for facilitating user selection of resource mode of distribution preferences according to one example.

### DETAILED DESCRIPTION

Certain aspects and features of the present disclosure relate to a system for facilitating user selection of one or more preferred resource modes of resource distribution. The system may also be operative to effectuate distribution of a resource to a user according to user-selected modes of distribution and resource allocation instructions. A type of a resource associated with a system and method according to examples of the disclosure can vary. For example, the resource may be a computing resource, including a processing resource (e.g., physical or virtual servers, applications) or a memory resource (e.g., disk storage) such as may be associated with a cloud computing environment. In another example, a resource may be a monetary resource such as a negotiable instrument, a dividend, or another type of transaction resource.

A user computing device can be initially connected to a remote computing system through which the resource is to be distributed. In some examples, the user computing device can be, for example, a personal computer, a laptop computer, a tablet, a smart phone, etc. In one example, the user computing device may be communicatively coupled to the remote computing system through the Internet. In such an example, communications between the user computing device and the remote computing system can be conducted using a web browser, and may employ various cryptographic communication protocols. In one particular example, the remote computing system may be a financial services computing system and the resource may be a monetary sum of a given value.

A user account associated with the user computing device can be authenticated by the remote computing system, and the remote computing system may display an initial user interface on the user computing device. The initial user interface can facilitate performance of various actions at and by the remote computing device. For example, when the remote computing device is a financial services computing device, the user computing device may facilitate user access to accounts, may be usable to initiate transactions, etc., either directly from the initial user interface or by redirection of the user to appropriate other user interfaces.

In one example, the user computing device may determine that a resource is to be distributed to the user upon connection of the user computing device to the remote computing system, such as through a notification that is received or accessible by the user computing device after user account authentication by the remote computing system. In another example, the user computing device may determine that a resource is to be distributed to the user as a result of a message sent to the user computing device, such as by the remote computing system. In another example, a user may be aware that a resource is being sent or transferred to the user by another party via the remote computing system. In still another example, a user may use the user computing device to request receipt of a resource upon connection of the user computing device to the remote computing system, such as a payment or transfer of a monetary sum from one or more financial accounts, or a payment that is owed to the user by an owner or operator of the remote computing system or by a third party.

When a resource is to be distributed to the user via the remote computing system, the system may facilitate access by the user computing device to a first resource distribution user interface via which the user may select resource distribution options. The first resource distribution user interface may be displayed on the user computing device as a result of a user action, or may be automatically displayed by the system, such as based on one of the example conditions described above. One or more additional resource distribution user interfaces may cooperate with the first resource distribution user interface to receive from the user computing device all the information required to distribute the resource to the user in a desired manner.

A plurality of selectable interface objects may be presented on the first resource distribution user interface. Each of the plurality of interface objects may represent a different mode of distribution by which a resource can be distributed to the user. The modes of distribution to be presented on the first resource distribution user interface by the representative interface objects may be determined in various ways. In one example, the system may always present the same selectable modes of distribution, regardless of the type or the value of the resource. In another example, the system may determine the modes of distribution to be presented on the first resource distribution user interface based on the type of the resource or a value of the resource. In still another example, the system may determine the modes of distribution to be presented on the first resource distribution user interface based on some combination of the type and/or the value of the resource to be distributed.

The system can detect a selection, via the user computing device, of one or more of the interface objects of the plurality of interface objects, where the selected interface objects represent the presented modes of distribution by which the user desires to receive a distribution of the resource. The interface objects may be selected using various selection techniques.

When more than one of the presented modes of distribution is selected, the system may present a second resource distribution user interface on the user computing device. The second resource distribution user interface may facilitate indication by the user of an allocation of the resource to each selected mode of distribution. In response to detecting the selection of the at least two interface objects and receiving the indicated resource allocation, the resource may be distributed to the user according to the selected modes of distribution and the selected resource allocation.

In some examples, the selection of the modes of distribution to be presented on the user computing device may be determined by a trained machine learning model. The trained machine learning model may be generated by training a machine learning model on training data comprising historical selection data associated with a plurality of historical resource mode of distribution selections executed by past users. The training data may also include value data for the resources represented in the historical selection data.

When provided with input data including an identification of the modes of distribution available to the remote computing system in conjunction with one or more of resource type information, resource value information, or a combination thereof, the trained machine-learning model can output a predicted plurality of resource modes of distribution most likely to be preferred by the user. Some or all the predicted plurality of resource modes of distribution can then be selected for presentation on the first resource distribution user interface.

These illustrative examples are provided to introduce the reader to the general subject matter discussed herein, and are not intended to limit the scope of the disclosed concepts. In the following description, various additional features and examples are described with reference to the drawings in which like numerals indicate like elements. Various implementations may be practiced without these specific details, and features can be combined together. The figures and description are not intended to be restrictive.

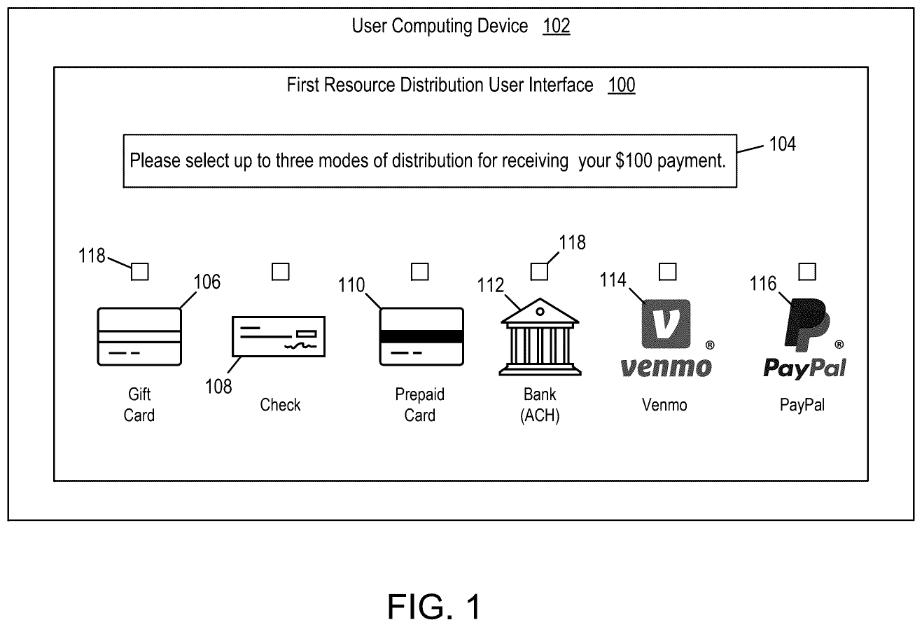

FIG. 1 is a block diagram depicting one example of a first resource distribution user interface 100 displayed on a user computing device 102. The user computing device 102 is communicatively coupled to a remote computing system through which a resource is to be distributed to the user. The first resource distribution user interface 100 may be displayed in response to any of the previously described actions, which include actions undertaken through or by the user computing device and automatic actions of the remote computing system upon connection of the user computing device to the remote computing system or upon other authentication of a user account associated with the user computing device by the remote computing system.

As shown, the first resource distribution user interface 100 may display a notification 104 or confirmation of a resource distribution to the user. The appearance and content of the notification 104 may vary. In this particular example, the notification 104 indicates that a resource in the form of a monetary payment is ready to be distributed to the user. The notification 104 also indicates that the value of the monetary payment is $100.

A plurality of selectable interface objects 106-116 are also presented on the first resource distribution user interface 100. The interface objects 106-116 represent various modes of distribution that are provided by the remote computing system and are selectable for receiving the resource. In this example, the modes of distribution include a gift (stored value) card 106, a paper check 108, a prepaid (e.g., physical or virtual) card 110, a bank (ACH) transfer 112 to a user account, a distribution via an intermediary service such as a Venmo® payment 114, and a distribution via another intermediary service such as a PayPal® payment 116. Other numbers or types of digital or physical modes of distribution may be presented on the first resource distribution user interface 100 in other examples.

One or more of the interface objects 106-116 may be selected by any of various techniques. For example, as shown in FIG. 1, a checkbox 118 may be associated with each of the interface objects 106-116 and can be selected via the user computing device to indicate that the mode of distribution represented by the associated interface object is a mode of distribution preferred by the user. In other examples, one or more of the modes of distribution may be selected by selecting the interface objects 106-116 themselves. Selection of a checkbox 118 associated with an interface object 106-116 or selection of an interface object itself may be accomplished, for example, using a keyboard, a mouse, or another input device that is a part of or is communicatively coupled to the user computing device 102. When the user computing device 102 includes a touchscreen, selection of one or more interface objects 106-116 may also be accomplished by touching a checkbox 118 or an interface object 106-116 with a finger of the user. In some examples, interface object 106-116 selection may be accomplished by dragging one or more of the interface objects 106-116 to a designated location on the first resource distribution user interface 100. The use of other interface object selection techniques are possible in other examples.

In some examples, the system may be a virtual reality or augmented reality system, and viewing of and interaction with at least the first resource distribution user interface 100 and additional resource distribution user interfaces may occur in a virtual reality or augmented reality environment. In such a case, selection of one or more of the interface objects 106-116 may be accomplished by hand gestures such as finger pinching, finger dragging, etc.

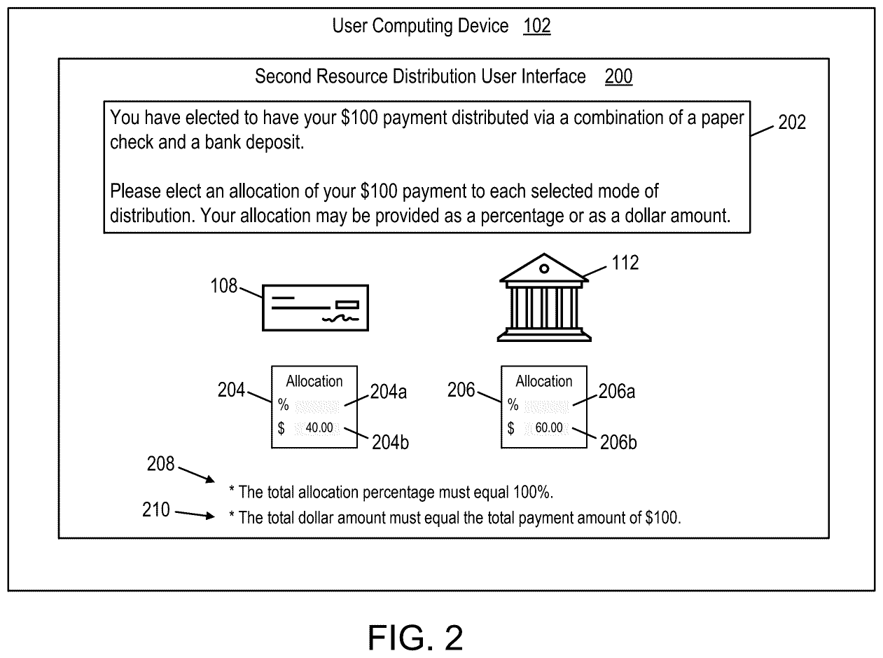

FIG. 2 is a block diagram depicting one example of an additional resource distribution user interface 200 displayed on the user computing device 102. The additional resource distribution user interface 200 may be displayed, for example, after selection of one or more modes of distribution presented on the first resource distribution user interface 100. In some examples, the additional resource distribution user interface 200 may be a new user interface presented on a new screen or webpage, while in other examples, the additional resource distribution user interface 200 may replace the first resource distribution user interface 100. In some examples, the additional resource distribution user interface 200 may be displayed only upon selection of at least two of the presented modes of distribution represented by the plurality of interface objects 106-116. In other examples, the additional resource distribution user interface 200 may be displayed even in a case where only one of the presented modes of distribution represented by the plurality of interface objects 106-116 is selected. In the latter case, the additional resource distribution user interface 200 may simply be a confirmation of the selected mode of distribution.

FIG. 2 depicts a case where two of the plurality of interface objects 106-116 representing a preferred two of the plurality of modes of distribution presented on the remote computing device have been selected. In this case, the selections indicate a preference to receive distribution of the resource ($100 payment) via a combination of a paper check 108 and a bank (ACH) transfer 112 to a user account. The user account may be located at a financial institution that owns or operates the remote computing system, or at another financial institution. In some cases, additional information such as, for example, bank routing or account numbers may be requested from the user when appropriate to a selected mode of distribution. Such a request may occur, for example, via a popup on the additional resource distribution user interface 200, or via another user interface.

The mode of distribution selections made via the first resource distribution user interface 100 may be confirmed on the additional resource distribution user interface 200 in various ways. For example, and as illustrated in FIG. 2, the previously selected user interface objects 108, 112 representing the paper check and bank (ACH) transfer modes of distribution may be displayed on the additional resource distribution user interface 200. Additionally, or in lieu thereof, a notification 202 or another informational message may be displayed on the additional resource distribution user interface 200 to confirm the mode of distribution selections, to provide instructions, or to communicate other information to the user. In this example, the notification 202 textually confirms the election to have the resource (the $100 payment) distributed via a combination of a paper check 108 and a bank transfer 112, and also instructs that an allocation of the $100 payment to each of the selected paper check 108 and bank transfer 112 modes of distribution is required. In this example, the notification instructions also advise that the allocation of the $100 payment to each of the selected paper check 108 and bank transfer 112 modes of distribution may be indicated as a percentage or a dollar amount. One or more additional notifications or instructions may also be displayed. For example, as indicated at 208, additional instructions may indicate that when the allocation by percentage option is selected, the total indicated allocation percentage must equal 100%. Likewise, as indicated at 210, additional instructions may indicate that when the allocation by dollar amount option is selected, the total indicated dollar amount must equal the total value of the resource ($100 in this case).

This example of the additional resource distribution user interface 200 also displays an allocation selection indication box 204 relative to the paper check 108 and an allocation selection indication box 206 relative to the bank transfer 112 modes of distribution. Each allocation selection indication box 204, 206 may include respective fields 204a, 206a via which a percentage allocation can be entered, and respective fields 206a, 206b via which a dollar amount allocation can be entered, with respect to each of the selected paper check 108 and bank transfer 112 modes of distribution. When entering a dollar amount, it may be required to enter an absolute value dollar amount or the system may automatically convert an entered negative dollar amount to an absolute value. As shown, $40 has been allocated to the paper check mode of distribution and $60 has been allocated to the bank transfer mode of distribution in this example. Various other methods for facilitating indication of a resource value allocation may be utilized in other examples.

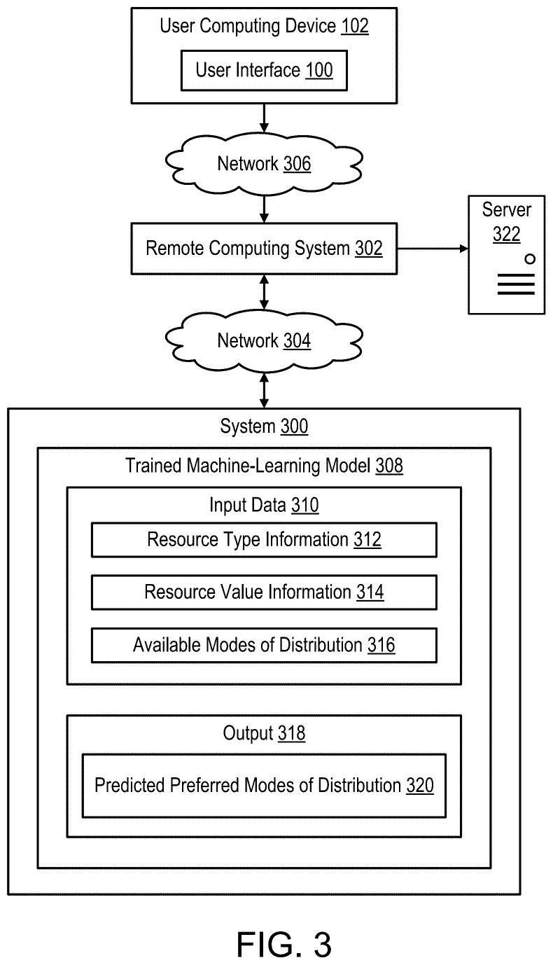

FIG. 3 is a block diagram illustrating one example of a machine-learning-based computing system 300 for facilitating selection of one or more preferred modes of distribution of a resource. The computing system 300 can determine what resource modes of distribution should be presented by the representative interface objects 106-116 on the first resource distribution user interface 100 displayed on the user computing device 102. In some examples, the computing system 300 may be operated by an owner or operator of a remote computing system 302, such as the remote computing system described relative to FIGS. 1-2. In other examples, the computing system 300 may be operated on behalf of the owner or operator of the remote computing system 302. In some examples, the computing system 300 may be a computing system of an entity such as a cloud service provider that facilitates distribution of computing resources such as processing and storage resources to users or a financial institution that facilitates distribution of resources such a monetary payments to users. In some examples, the remote computing system 302 may be communicatively coupled to one or more remote servers 324 or other remote computing systems, and may utilize the one or more remote servers 324 or other remote computing systems to distribute resources to users at least with respect to certain modes of distribution (e.g., a stored value card mode of distribution).

The computing system 300 can include various processing and other hardware and software or application components. The computing system 300 may be a standalone computing system such as a desktop or laptop computer, a mobile device, etc. In other examples, the computing system 300 may be a server, or a distributed computing system having multiple servers, virtual machines, etc. In still other examples, the computing system 300 may be a cloud-based computing system that utilizes one or more physical or virtual servers and data storage of a cloud service provider.

The computing system 300 may communicate with the remote computing system 302 over a network 304, and the user computing device 102 may similarly communicate with the remote computing system 302 over a network 306. Either or both of the networks 304, 306 may be a local area network (LAN), a wide-area network (WAN) such as the Internet, an institutional network, cellular or other wireless networks, virtual networks such as an intranet or an extranet, etc.

The computing system 300 can include a trained machine-learning model 308. The trained machine-learning model 308 can be provided with input data 310. In this example, the input data 310 may include resource type information 312 and the resource value 314 information associated with a resource to be distributed to a user. The input data 310 may also include an identification of all the modes of distribution 316 that can be provided by the remote computing system 302. The trained machine-learning model 308 can be trained to generate an output 318 based on input of some or all of the input data 310 to the trained machine-learning model 308. In some examples, only the resource type information 312 and the available modes of distribution information 316 may be input to the trained machine-learning model 308. In some examples, only the resource value information 314 and the available modes of distribution information 316 may be input to the trained machine-learning model 308. In other examples, different combinations of the resource type information 312, the resource value 314 information, and the available modes of distribution 316, may be input to the trained machine-learning model 308.

The output 318 of the trained machine-learning model 308 may be a prediction 320 of one or more of the available modes of distribution in the remote computing system will be preferred by the user for distribution of the resource (e.g., the $100 payment) of FIGS. 1-2. In some examples, the prediction 320 may be based only on the type of the resource and the available modes of distribution in the remote computing system 302. In some examples, the prediction 320 may be based only on the value of the resource and the available modes of distribution in the remote computing system 302. In other examples, the prediction 320 may be based on a combination of one or more of the type of the resource and the value of the resource, in conjunction with the available modes of distribution in the remote computing system 302. Various restrictions may be placed on the output 318 of the trained machine-learning model 308. For example, the output 318 of the trained machine-learning model 308 may be restricted to limit the predicted modes of distribution preferred by the user to some predetermined number of the available modes of distribution.

In some examples, the trained machine-learning model 308 may rank or otherwise assign weight to the predicted modes of distribution that will be preferred by the user. The ranking or weighting may be used by the computing system 300 to determine which of the predicted modes of distribution should be presented to the user in cases where all of the predicted modes of distribution are not presented to the user.

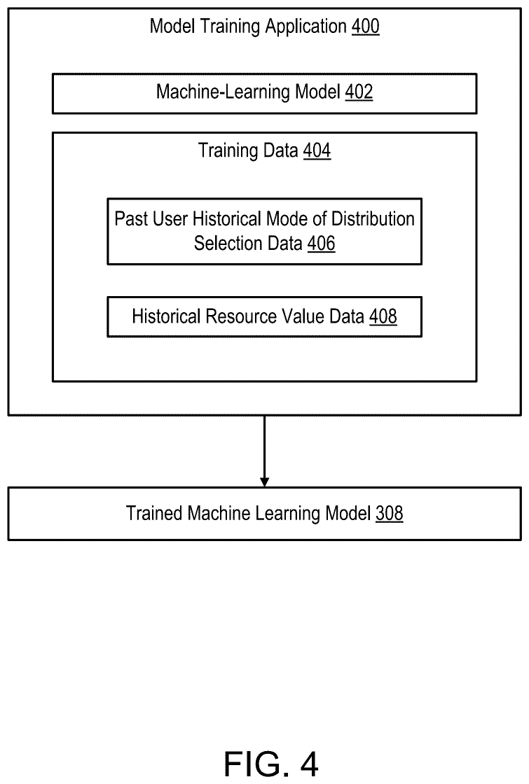

FIG. 4 is a block diagram of an example of a model-training application 400 that can be implemented to train a machine-learning model 402 to generate a trained machine-learning model, such as the trained machine-learning model 308 of FIG. 3. The model-training application 400 may be a part of the computing system 300, or the model-training application 400 may be separate and remote from the computing system 300. Training the machine-learning model 402 can transform the machine-learning model 402 from an untrained state to a trained state (i.e., to a trained machine-learning model).

Various techniques may be utilized to train the machine-learning model 402. For example, the training data 404 may be provided to the machine-learning model in an iterative manner to enable the machine-learning model 402 to identify trends or relationships in the training data 404. The machine-learning model training may be supervised training, unsupervised training, or a semi-supervised training. Parameter or hyperparameter adjustment may also be utilized to minimize a loss function of the machine-learning model 402.

Training the machine-learning model 402 can include accessing the training data 404, which may be stored, for example, at the computing system 300 or at a database or another storage location that is remote from but accessible by the computing system 300. The training data 404 may include historical selection data 406 associated with a plurality of historical resource mode of distribution selections executed by past users. The historical selection data 406 may include, among other information, an identification of the type of each resource represented in the historical selection data 406. The training data 404 can also include value data 408 that associates a value with each of the resources represented in the historical selection data 406. The values provided in the value data 408 may be monetary values or values of another nature, depending on the resource type.

In some examples, each of the historical selection data 406 and the value data 408 may be individually used to train the machine-learning model 402 to generate a trained machine-learning model 308 that can predict one or more resource modes of distribution preferred by a given user. In such a case, the resulting trained machine-learning model 308 may be trained to predict one or more resource modes of distribution preferred by a given user based only on the information associated with the selected training data, 406, 408. For example, if only the value data 408 is used to train the machine-learning model 402, the resulting trained machine-learning model 308 may predict one or more resource modes of distribution preferred by a given user based only on the value of the resource to be distributed to the user.

In other examples, different combinations of the historical selection data 406 and the value data 408 may be used to train the machine-learning model 402. This may enable the resulting trained machine-learning model 308 to more accurately predict one or more resource modes of distribution preferred by a given user, as it is possible that user mode of distribution preferences may frequently be based on more than one factor. To this end, in some examples, all of the historical selection data 406 and the value data 408 may be used in combination to train the machine-learning model 402. In some examples, one or more of the historical selection data 406 the value data 408 may be weighted prior to being provided to the machine-learning model 402 for training. For example, if it is understood that user mode of distribution selections are most heavily influenced by the value of the resource, then the value data 408 may be assigned more weight than the historical selection data 406 during training of the machine-learning model 402.

While not shown in FIGS. 3-4, it is possible in some examples to also include past user demographic data in the training data 404, and to further use the past user demographic data to train the machine learning model 402. For example, the training data 404 may include demographic data for the past users represented in the historical selection data 406. The past user demographic data may include, for example, user age, user gender, user location (e.g., residence information), and user financial information including but not limited to user income and user bank account information. Other past user information that may be usable to identify trends in user mode of distribution preferences may also be included in the past user demographic data. When provided, the past user demographic data may be used with different combinations of the historical selection data 406 and the value data 408 to train the machine learning model 402. The resulting trained machine learning model 308 may then be able to rely on user demographic information to predict the user preferred modes of distribution 322, whether exclusively or in conjunction with different combinations of the resource type information 312, resource value 314 information, and identification of the available modes of distribution 316.

Various fitting, estimation, or other model-training optimization techniques can be used to ensure that, upon evaluation, the predictive output of the machine-learning model 402 is accurate given the input data (i.e., to minimize the loss function). The resulting trained machine-learning model 308 can then be deployed for application to newly received input data, as described above.

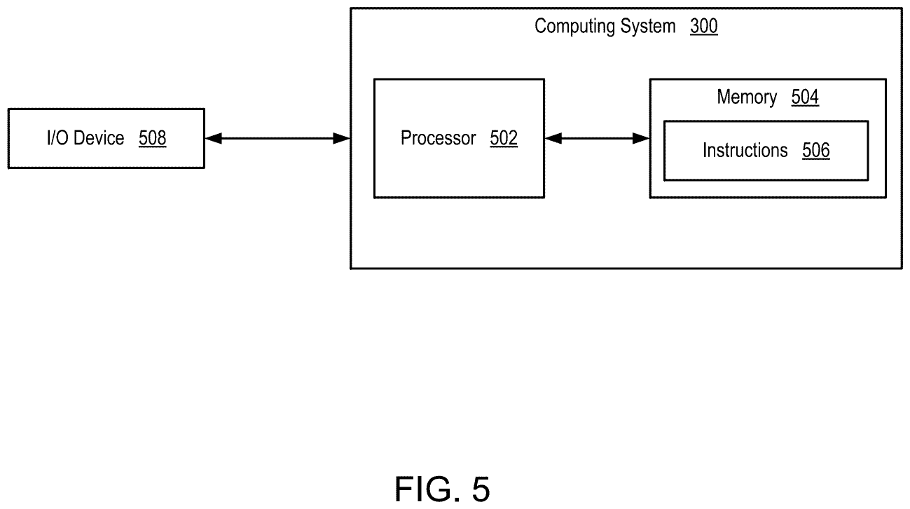

FIG. 5 is a block diagram illustrating various components of one example of a computing system, such as the computing system 300 of FIG. 3, that is usable to facilitate user indication of one or more preferred modes of distribution by which to receive a resource. As illustrated, the computing system 300 may include a processor 502. The processor 502 can include one processing device or multiple processing devices. Non-limiting examples of the processor 502 include a Field-Programmable Gate Array (FPGA), an application-specific integrated circuit (ASIC), a microprocessor, etc. A memory 504 may be communicatively coupled to the processor 502. The memory 504 can include instructions that are executable by the processor 502 to cause the processor 502 to perform operations. In some examples, the instructions 506 can include processor-specific instructions generated by a compiler or an interpreter from code written in a suitable computer-programming language, such as C, C++, C#, etc.

The memory 504 can include one memory or multiple memories. The memory 504 can be non-volatile and may include any type of memory that retains stored information when powered off. Non-limiting examples of the memory 504 include electrically erasable and programmable read-only memory (EEPROM), flash memory, or any other type of non-volatile memory. At least some of the memory 504 can be a non-transitory computer-readable medium from which the processor 502 can read the instructions 506. A computer-readable medium can include electronic, optical, magnetic, or other storage devices capable of providing the processor 502 with computer-readable instructions or other program code. Non-limiting examples of a computer-readable medium include magnetic disk(s), memory chip(s), ROM, random-access memory (RAM), an ASIC, a configured processor, optical storage, or any other medium from which the processor 502 can read the instructions 506. In some examples, the memory 504 may include the trained machine-learning model 308.

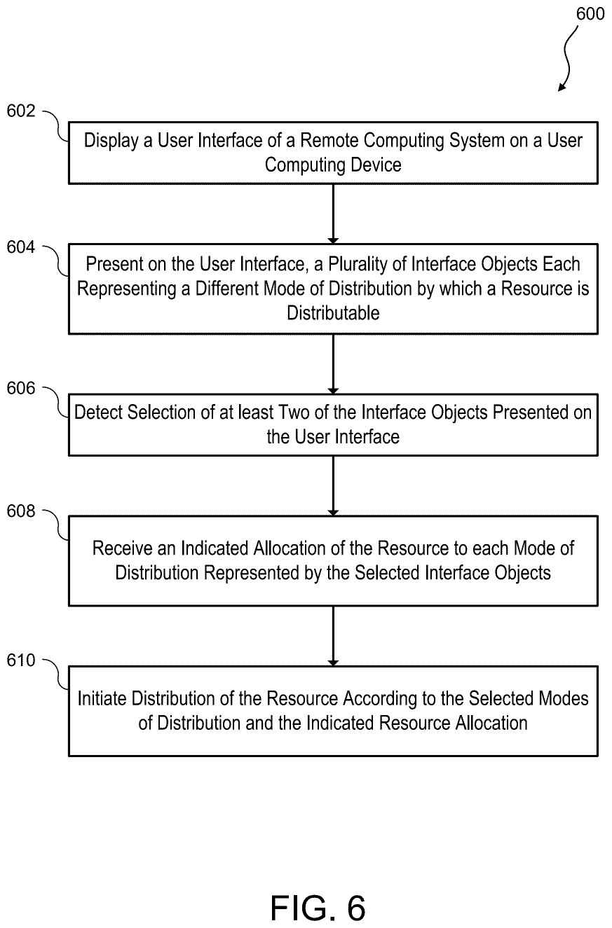

FIG. 6 is a flowchart 600 of one example of a computer-implemented method for facilitating selection of one or more resource modes of distribution. A user computing device may initially establish a secure connection with a remote computing system that will be used to distribute the resource to the user. The remote computing system may then authenticate a user account associated with the user computing device through login credentials or otherwise. In some examples, the user computing device may determine that a resource is to be distributed to the user upon connection of the user computing device to the remote computing system. In another example, the user computing device may determine that a resource is to be distributed to the user as a result of a message sent to the user computing device, such as by the remote computing system. In some examples, the remote computing system may be a financial institution computing system and the user may be a customer of the financial institution. In some examples, the remote computing system may be a cloud-based computing system hosted by a cloud service provider. The remote computing system may also include a host server, which can be a physical or virtual server.

As indicated in block 602 of the flowchart 600, after the user account associated with the user computing device is authenticated to communicate with the remote computing system, a user interface of the remote computing system may be displayed on the user computing device. The user interface may be a customizable resource distribution user interface. The resource distribution user interface may be a first resource distribution user interface of a plurality of related and cooperating resource distribution user interfaces.

In block 604 of the flowchart 600, a plurality of interface objects may be presented on the user interface. Each interface object of the plurality of interface objects can represent a different mode of distribution by which the resource is distributable to the user. The modes of distribution represented by the interface objects may be selected for presentation on the user computing device based on one or more of a resource type, and a resource value. In some examples, selection of the modes of distribution represented by the interface objects may be performed by a trained machine learning model that is applied to one or more of the resource type information and resource value information. The trained machine-learning model may have been previously trained on training data comprising one or more of historical selection data associated with a plurality of resource historical mode of distribution selections executed by past users, and value data that associates a value with each of the resources represented in the historical selection data.

At block 606 of the flowchart 600, a selection of at least two interface objects of the plurality of interface objects can be detected by the user interface. The interface objects may be selected in various ways. For example, the interface objects may be selected using an input device such as a keyboard or mouse to select checkboxes associated with the interface objects or to select the interface objects themselves. Selection of the interface objects may also be accomplished, for example, by dragging the interface objects to a designated area of the user interface using the input device. In some examples, the system may be a virtual reality (VR) or an augmented reality (AR) system, and selection of the interface objects may be accomplished using hand gestures, finger gestures, or any other functional VR or AR object selection technique.

As indicated in block 608 of the flowchart 600, the user interface may be configured to receive an indicated allocation of the resource to each mode of distribution represented by the selected at least two interface objects. In some examples, the user interface for receiving the allocation information may be an additional user interface of a plurality of cooperating resource distribution user interfaces. In some examples, the allocation may be provided as a percentage, or as an absolute value (e.g., a non-negative monetary value).

From block 610 of the flowchart 600, it may understood that in response to detecting the selection of the at least two interface objects and receiving the indicated allocation of the resource, a distribution of the resource to the user may be initiated according to the selected modes of distribution and the indicated resource value allocation. In some examples, distribution of the resource to the user may be accomplished entirely by the remote computing system. In other examples, distribution of the resource to the user may involve, for example, communications with one or more remote servers or other computing systems that are configured to distribute the resource to the user according to one or more of the user-selected modes of distribution.

In one example, a system for facilitating user selection of one or more preferred resource modes of resource distribution may be a payment system of a financial institution. In some examples, the payment system may be deployed in a cloud-computing environment where one or more payment applications execute on one or more physical or virtual servers of a cloud services provider. Communications between a user computing device and the payment system may be web-based communications that occur over the Internet and are initiated by the user computing device using a web browser. A payment initiation application of the payment system may manage both a user account authentication portion and a payment distribution portion of the payment process. For example, when the payment system receives a request for payment from a user computing device, the payment initiation application can authenticate the user account associated with the user computing device and can thereafter present a plurality of interface objects on a user interface of the user computing device, where the plurality of interface objects represent multiple selectable modes of distribution for the payment. The system can then facilitate selection of one or more of the multiple modes of payment distribution and selection of a preferred allocation of the payment among the selected modes of distribution. The system may thereafter cause the payment to be distributed to the user via the user-selected modes of distribution and according to the user-specified allocation of the payment.

The foregoing description of certain examples, including illustrated examples, has been presented only for purposes of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a resource distribution computing system communicatively couplable between a user computing device and a machine-learning based computing system, the resource distribution computing system including a first processor and a memory communicatively coupled to the first processor, the memory including instructions that are executable by the first processor to cause the resource distribution computing system to perform operations comprising:
authenticating a user of the user computing device to interact with the resource distribution computing system via information received from the user computing device over a first network;
after authenticating the user, identifying a resource to be distributed to the user based at least in part on user identity information present in the information received from the user computing device;
after identifying the resource to be distributed to the user, transmitting a first command to the machine-learning based computing system over a second network to cause the machine-learning based computing system to determine which of a plurality of possible different modes of distribution via which the resource is distributable to the user by the resource distribution computing system to present on the user computing device, where the modes of distribution to be presented on the user computing device are determinable by the machine-learning based computing system by:
providing, by a second processor of the machine-learning based computing system to a trained machine-learning model of the machine-learning based computing system, an input received in the first command from the resource distribution computing system, wherein the input comprises an identification of the modes of distribution via which the resource is distributable to the user by the resource distribution computing system and one or more of the resource type and the resource value, and wherein the trained machine-learning model is trained on training data comprising one or more of historical selection data associated with a plurality of resource historical mode of distribution selections, and value data that associates a value with each resource type represented in the historical selection data, and
in response to the input, generating an output, by the trained machine-learning model, that includes a predicted plurality of the available modes of distribution of the resource distribution computing system that are most likely to be selected by the user,
receiving, from the machine-learning based computing system, the predicted plurality of the available modes of distribution of the resource distribution computing system that are most likely to be selected by the user;
selecting at least some of the predicted plurality of the available modes of distribution for presentation on and selection via the user computing device;
transmitting a second command to the user computing device over the first network to cause a third processor of the user computing device to display a user interface where each mode of distribution of the at least some of the predicted plurality of the available modes of distribution is represented by a unique user interface object;
receiving, from the user computing device, resource distribution information comprising at least two selected modes of distribution resulting from a user selection of at least two interface objects of the interface objects presented on the user interface of the user computing device, and an allocation of the resource to each of the selected modes of distribution; and
in response to receiving the resource distribution information from the user computing device, initiating a distribution of the resource to the user according to the at least two selected modes of distribution and the indicated resource allocation identified in the resource distribution information.

2. The system of claim 1, wherein the operation of initiating the distribution of the resource to the user by the resource distribution computing system further comprises causing another remote computing system to distribute the resource to the user according to the at least two selected modes of distribution and the indicated resource allocation identified in the resource distribution information received from the user computing device.

3. The system of claim 1, wherein the operations further comprise:
causing the user computing device to present an interface object of the interface objects on the user interface as a non-selectable interface object to indicate that the mode of distribution represented by the non-selectable interface object is not available as a mode of distribution of the resource by the resource distribution computing system; and
causing an appearance of the non-selectable interface object to differ from an appearance of selectable interface objects of the interface objects.

4. The system of claim 1, wherein the input includes the resource value, and the indicated allocation of the resource to each mode of distribution represented by the selection of the at least two interface objects is a percentage of the resource value or an absolute value.

5. The system of claim 1, wherein:
the input to the trained machine-learning model further comprises user demographic information;
the trained machine-learning model is trained on training data further comprising demographic data for past users represented in the historical selection data;
the demographic data for the past users is selected from the group consisting of user age, user gender, user location, user financial information, and combinations thereof; and
the output of the trained machine-learning model is also based in part on the user demographic information.

6. The system of claim 1, wherein:
the predicted plurality of available modes of distribution most likely to be selected includes ranking information; and
the operation of selecting, by the resource distribution computing system, the at least some of the predicted plurality of the available modes of distribution for presentation on and selection via the user computing device is based, at least in art, on the ranking information.

7. The system of claim 1, wherein the modes of distribution represented by the interface objects on the user interface of the user computing device include digital modes of distribution and physical modes of distribution.

8. A computer-implemented method comprising:
communicatively coupling a resource distribution computing system between a user computing device and a machine-learning based computing system;
authenticating, by the resource distribution computing system, a user of the user computing device to interact with the resource distribution computing system, using information received from the user computing device over a first network;
after authenticating the user, identifying, by the resource distribution computing system, a resource to be distributed to the user based at least in part on user identity information present in the information received from the user computing device;
after identifying the resource to be distributed to the user, transmitting, by the resource distribution computing system, a first command to the machine-learning based computing system over a second network that causes the machine-learning based computing system to determine which of a plurality of possible different modes of distribution via which the resource is distributable to the user by the resource distribution computing system to present on the user computing device, where the modes of distribution to be presented on the user computing device are determined by the machine-learning based computing system by:
providing, by a second processor of the machine-learning based computing system to a trained machine-learning model of the machine-learning based computing system, an input received in the first command from the resource distribution computing system, wherein the input comprises an identification of the modes of distribution via which the resource is distributable to the user by the resource distribution computing system and one or more of the resource type and the resource value, and wherein the trained machine-learning model is trained on training data comprising one or more of historical selection data associated with a plurality of resource historical mode of distribution selections, and value data that associates a value with each resource type represented in the historical selection data, and
in response to the input, generating an output, by the trained machine-learning model, that includes a predicted plurality of the available modes of distribution of the resource distribution computing system that are most likely to be selected by the user,
receiving, by the resource distribution computing system, from the machine-learning based computing system, the predicted plurality of the available modes of distribution of the resource distribution computing system that are most likely to be selected by the user;
selecting, by the resource distribution computing system, at least some of the predicted plurality of the available modes of distribution for presentation on and selection via the user computing device;
transmitting, by the resource distribution computing system, over the first network, a second command to the user computing device that causes a third processor of the user computing device to display a user interface where each mode of distribution of the at least some of the predicted plurality of the available modes of distribution is represented by a unique user interface object;
receiving, by the resource distribution computing system, from the user computing device, resource distribution information comprising at least two selected modes of distribution resulting from a user selection of at least two interface objects of the interface objects presented on the user interface of the user computing device, and an allocation of the resource to each of the selected modes of distribution; and
in response to receiving the resource distribution information from the user computing device, initiating, by the resource distribution computing system, a distribution of the resource to the user according to the at least two selected modes of distribution and the indicated resource allocation identified in the resource distribution information.

9. The computer-implemented method of claim 8, wherein initiating the distribution of the resource to the user by the resource distribution computing system further comprises causing another remote computing system to distribute the resource to the user according to the at least two selected modes of distribution and the indicated resource allocation identified in the resource distribution information received from the user computing device.

10. The computer-implemented method of claim 8, wherein the operations further comprise:
presenting an interface object of the interface objects on the user interface as a non-selectable interface object to indicate that the resource is not distributable to the user using the mode of distribution represented by the non-selectable interface object; and
causing an appearance of the non-selectable interface object to differ from an appearance of selectable interface objects of the interface objects.

11. The computer-implemented method of claim 8, wherein the input received by the machine-learning based computing system in the first command from the resource distribution computing system includes the resource value and the indicated allocation of the resource to each mode of distribution represented by the selection of the at least two interface objects is received as a percentage of the resource value or as an absolute value.

12. The computer-implemented method of claim 8, wherein:
the input to the trained machine-learning model further comprises user demographic information;
the trained machine-learning model is trained on training data further comprising demographic data for past users represented in the historical selection data;
the demographic data for the past users is selected from the group consisting of user age, user gender, user location, user financial information, and combinations thereof; and
the output of the trained machine-learning model is also based in part on the user demographic information.

13. The computer-implemented method of claim 8, wherein:
the predicted plurality of available modes of distribution most likely to be selected are each ranked by the trained machine-learning model; and
the selecting, by the resource distribution computing system, of the at least some of the predicted plurality of the available modes of distribution for presentation on and selection via the user computing device is based, at least in part, on the rank of each of the at least some of the predicted plurality of the available modes of distribution.

14. non-transitory computer-readable medium comprising instructions that are executable by a first processor of a resource distribution computing system for causing the resource distribution computing system to perform operations comprising:
authenticating, via information received from a user computing device communicatively coupled to the resource distribution computing system over a first network, a user of the user computing device to interact with the resource distribution computing system;
after authenticating the user, identifying a resource to be distributed to the user based at least in part on user identity information present in the information received by the resource distribution computing system from the user computing device;
after identifying the resource to be distributed to the user, transmitting a first command to a machine-learning based computing system communicatively coupled to the resource distribution computing system over a second network to cause the machine-learning based computing system to determine which of a plurality of possible different modes of distribution via which the resource is distributable to the user by the resource distribution computing system to present on the user computing device, where the modes of distribution to be presented on the user computing device are determinable by the machine-learning based computing system by:
providing, by a second processor of the machine-learning based computing system to a trained machine-learning model of the machine-learning based computing system, an input received in the first command from the resource distribution computing system, wherein the input comprises an identification of the modes of distribution via which the resource is distributable to the user by the resource distribution computing system and one or more of the resource type and the resource value, and wherein the trained machine-learning model is trained on training data comprising one or more of historical selection data associated with a plurality of resource historical mode of distribution selections, and value data that associates a value with each resource type represented in the historical selection data, and
in response to the input, generating an output, by the trained machine-learning model, that includes a predicted plurality of the available modes of distribution of the resource distribution computing system that are most likely to be selected by the user, receiving, from the machine-learning based computing system, the predicted plurality of the available modes of distribution of the resource distribution computing system that are most likely to be selected by the user;
selecting at least some of the predicted plurality of the available modes of distribution for presentation on and selection via the user computing device;
transmitting a second command to the user computing device over the first network to cause a third processor of the user computing device to display a user interface where each mode of distribution of the at least some of the predicted plurality of the available modes of distribution is represented by a unique user interface object;
receiving, from the user computing device, resource distribution information comprising at least two selected modes of distribution resulting from a user selection of at least two interface objects of the interface objects presented on the user interface of the user computing device, and an allocation of the resource to each of the selected modes of distribution; and
in response to receiving the resource distribution information from the user computing device, initiating a distribution of the resource to the user according to the at least two selected modes of distribution and the indicated resource allocation identified in the resource distribution information.

15. The non-transitory computer-readable medium of claim 14, wherein the operation of initiating the distribution of the resource to the user by the resource distribution computing system further comprises causing another remote computing system to distribute the resource to the user according to the at least two selected modes of distribution and the indicated resource allocation identified in the resource distribution information received from the user computing device.

16. The non-transitory computer-readable medium of claim 14, wherein the operations further comprise:
causing the user computing device to present an interface object of the interface objects on the user interface as a non-selectable interface object to indicate that the mode of distribution represented by the non-selectable interface object is not available as a mode of distribution of the resource by the resource distribution computing system; and
causing an appearance of the non-selectable interface object to differ from an appearance of selectable interface objects of the interface objects.

17. The non-transitory computer-readable medium of claim 14, wherein the input includes the resource value, and the indicated allocation of the resource to each mode of distribution represented by the selection of the at least two interface objects is a percentage of the resource value or an absolute value.

18. The non-transitory computer-readable medium of claim 14, wherein:
the input to the trained machine-learning model further comprises user demographic information;
the trained machine-learning model is trained on training data further comprising demographic data for past users represented in the historical selection data;
the demographic data for the past users is selected from the group consisting of user age, user gender, user location, user financial information, and combinations thereof; and
the output of the trained machine-learning model is also based in part on the user demographic information.

19. The non-transitory computer-readable medium of claim 14, wherein:
the predicted plurality of available modes of distribution most likely to be selected includes ranking information; and
the operation of selecting, by the resource distribution computing system, the at least some of the predicted plurality of the available modes of distribution for presentation on and selection via the user computing device is based, at least in art, on the ranking information.

20. The non-transitory computer-readable medium of claim 14, wherein the modes of distribution represented by the interface objects on the user interface of the user computing device include digital modes of distribution and physical modes of distribution.
